(19) United States
(12) Patent Application Publication
(10) Pub. No.: US 2016/0321575 A1
(43) Pub. Date: Nov. 3, 2016

(54) SCORING ENTRIES IN A REPOSITORY OF BUSINESS PROCESS MODELS TO FACILITATE SEARCHING

(71) Applicant: International Business Machines Corporation, Armonk, NY (US)

(72) Inventors: Miao He, Beijing (CN); Changrui Ren, Beijing (CN); Ajay Satsangi, Charlotte, NC (US); Qinhua Wang, Beijing (CN); Qiang Wei, Beijing City (CN)

(21) Appl. No.: 14/700,439

(22) Filed: Apr. 30, 2015

(51) Int. Cl. G06Q 10/06; G06F 17/30

(52) U.S. Cl. CPC G06Q 10/067; G06Q 10/06393; G06F 17/30864

(57) ABSTRACT

In one example, a computer-implemented method includes evaluating pairwise relationships between pairs of business process models stored in a repository, constructing a network that encodes the pairwise relationships, and calculating a score for each of the plurality of business process models by traversing the network, wherein the score is a function of the pairwise relationships between an associated one of the plurality of business process models and others of the plurality of business process models.

### BACKGROUND

This disclosure relates generally to the field of systems engineering, and relates more specifically to business process modeling.

Business process modeling is the act of modeling the processes (e.g., activities, sequences, etc.) of a business, for instance to facilitate analysis, comparison, and/or improvement of current processes. For example, a goal of business process modeling may be to increase the speed of a process, improve the quality of a process result, or reduce the costs (e.g., labor, materials, capital, etc.) associated with a process.

### SUMMARY

In one example, a computer-implemented method includes evaluating pairwise relationships between pairs of business process models stored in a repository, constructing a network that encodes the pairwise relationships, and calculating a score for each of the plurality of business process models by traversing the network, wherein the score is a function of the pairwise relationships between an associated one of the plurality of business process models and others of the plurality of business process models.

In another example, a computer-implemented method includes receiving a search query comprising a keyword, identifying a plurality of business process models that match the keyword, wherein the business process models are stored in a repository, and ranking the plurality of business process models according to a score associated with each of the plurality of business process models, wherein each score reflects a relationship of an associated one of the plurality of business process models to other business process models stored in the repository.

In another example, a system includes a repository storing a plurality of business process models and an apparatus for scoring the plurality of business process models. The apparatus includes a first processor for evaluating pairwise relationships between each pair of the plurality of business process models, a network builder for constructing a network to encode the pairwise relationships, and a second processor for calculating a score for at least one of the plurality of business process models, based on the pairwise relationships encoded in the network.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of one example of a system for scoring and searching entries in a repository of business process models;

FIG. 2 is a flow diagram illustrating one example of a high level computer-implemented method for determining the relevance of a business process model;

FIG. 3 illustrates an example network of business process models;

FIG. 4 is a flow diagram illustrating one example of a computer-implemented method for constructing a network of business process models;

FIG. 5 is a flow diagram illustrating one example of a computer-implemented method for assigning a score to a business process model;

FIG. 6 is a flow diagram illustrating a high level computer-implemented method for searching a repository of business process models; and

FIG. 7 depicts a high-level block diagram of a computer that can be transformed into a machine capable of performing the functions described herein.

### DETAILED DESCRIPTION

In one example, the present disclosure is related to a computer-implemented method, non-transitory computer readable medium, and apparatus for scoring entries in a repository of business process models to facilitate searching. An enterprise may store its business process models in a repository. Over time, the number of business process models stored in the repository will grow. For instance, the repository for a large, established enterprise may store several hundred business process models, and many of these stored business process models may share some similarities. Thus, when one searches the repository for business process models having desired characteristics, it can be difficult to identify the most relevant search results in an efficient manner. For example, simple keyword searches based on text similarity can return a large number of results, but typically provide no meaningful way to assess their relative relevance. More targeted searches also consider the structural and behavioral similarities between a query and the stored process models; however, these searches tend to be computationally complex and time consuming, and are not particularly user friendly.

One example of the present disclosure discovers relationships between business process models stored in a repository. The relevance of a given business process model to a particular topic may then be inferred from its relationships with other business process models. The inferred relevance is then used to rank query results obtained using a keyword-based search. The present disclosure thus provides a meaningful, user-friendly way of identifying the most relevant items in a potentially large set of search results.

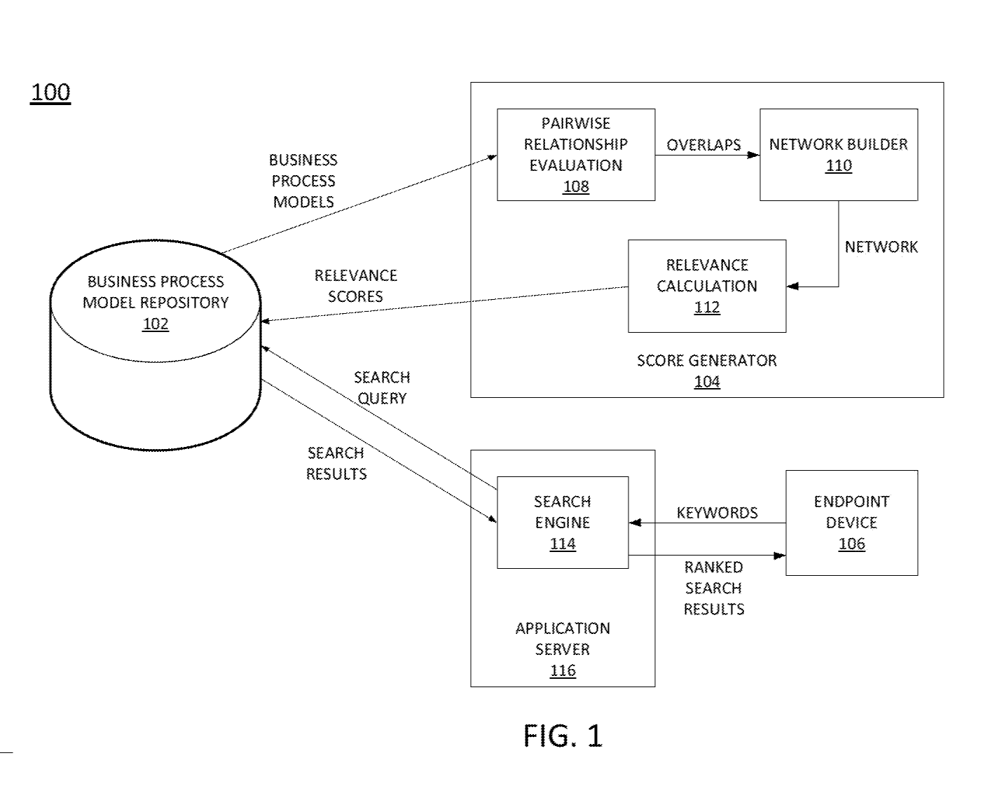

FIG. 1 illustrates a block diagram of one example of a system 100 for scoring and searching entries in a repository 102 of business process models. As illustrated, the system 100 generally comprises the repository 102, a score generator 104, at least one endpoint device 106, and a search engine 114 (hosted, for example, on an application server 116).

The repository 102 is a database that stores business process models for an enterprise. In one example, several hundred business process models may be stored in the repository 102. These business process models may describe various activities and sequences used by the enterprise in the course of operation.

The score generator 104 comprises a device that generates a score for each business process model in the repository 102. In one example, the score generator 104 includes at least one processor and may be implemented using a general purpose computing device that is transformed, through execution of the methods disclosed herein, into a special purpose computing device. The score that is generated by the score generator 104 indicates the relevance of an associated business process model to a given topic. The score generator 102 further comprises a pairwise relationship evaluation processor 108, a network builder 110, and a relevance calculation processor 112.

The pairwise relationship evaluation processor 108 is a processor that identifies and records relationships between each pair of business process models in the repository 102. In one example, the pairwise relationship is a temporal relationship and/or a substantive relationship. A temporal pairwise relationship relates to the time order between two business process models (e.g., which business process model was created or uploaded into the repository 102 first). A substantive pairwise relationship relates to overlapping content shared by two business process models (e.g., a percentage of shared content or specific sections of content that are shared).

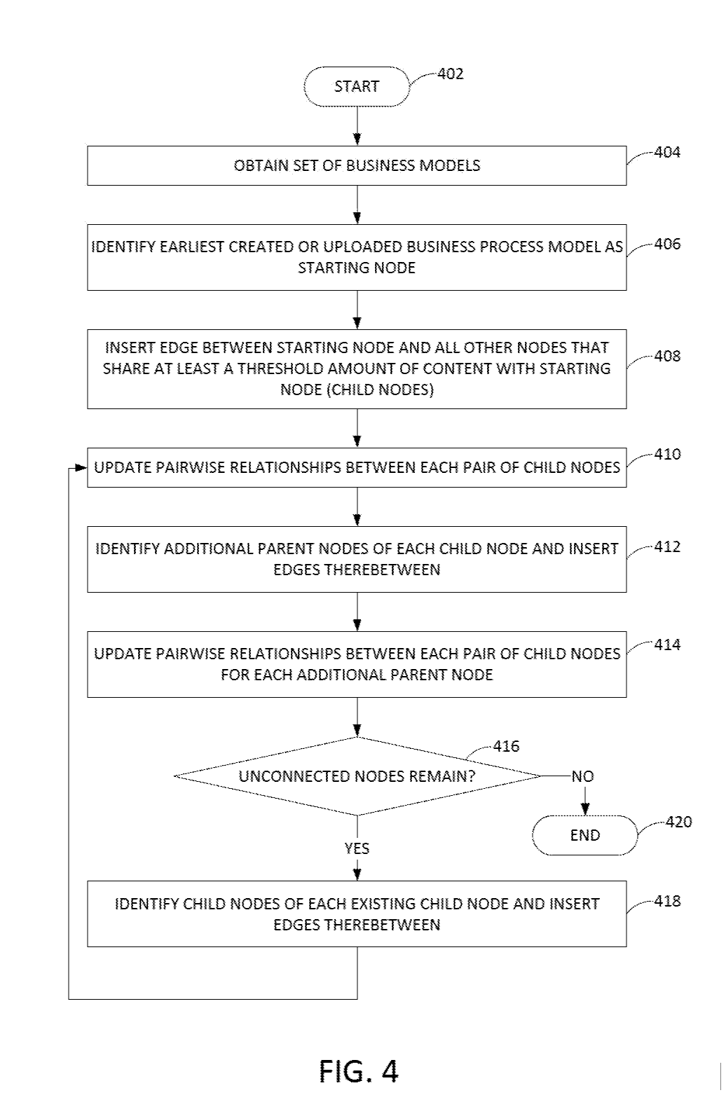

The network builder 110 is a processor that uses the pairwise relationships between business process models to build a network that visually represents these relationships. Once example of a computer-implemented method for building a network of business process models is discussed in greater detail in connection with FIG. 4.

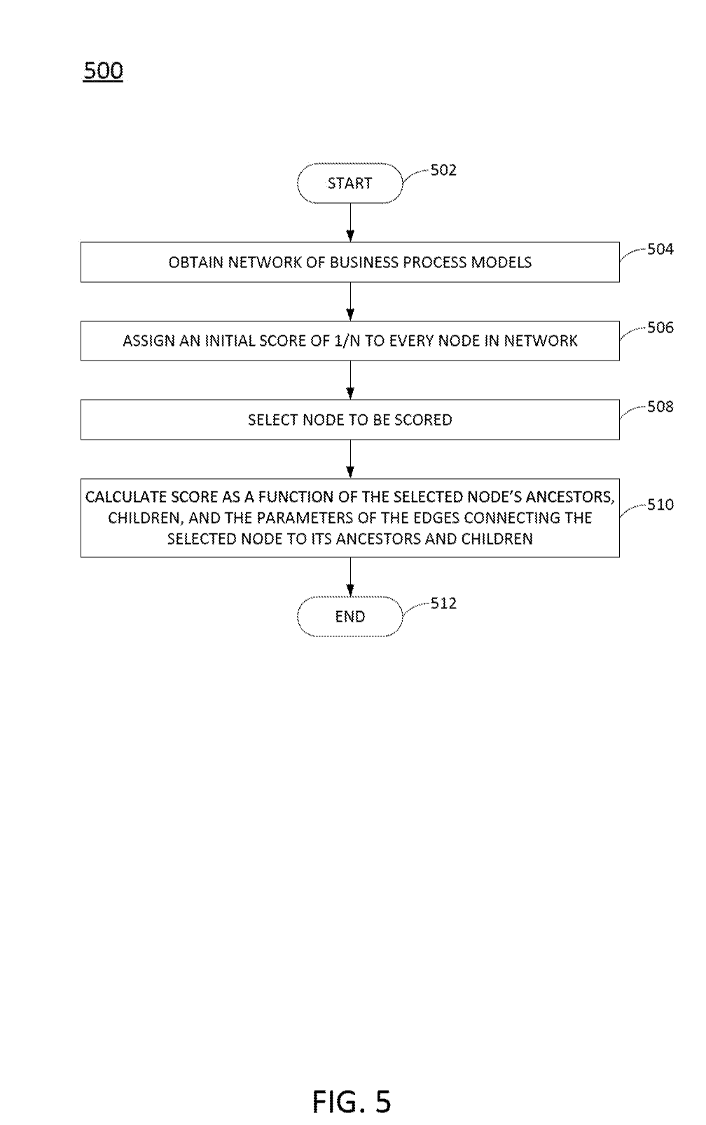

The relevance calculation processor 112 is a processor that computes a score for each business process model in the repository. The score is a quantitative indication of a business process model's relevance to a given topic. In one example, the relevance calculation processor 112 uses information from the network of business process models to compute the scores. Thus, the score for a given business process model takes into account that business process model's relationships with other business process models that may also be relevant to the given topic. One example of a computer-implemented method for calculating a score for a business process model is discussed in greater detail in connection with FIG. 5. The computed scores may be stored in the repository 102 with the associated business process models.

In addition, the system 100 includes at least one endpoint device 106. The endpoint device 106 is any type of endpoint device that is capable of accessing the search engine 114 over a communication network, such as a desktop computer or a mobile endpoint device such as a cellular telephone, a smart phone, a tablet computer, a laptop computer, a netbook, an ultrabook, a portable media device (e.g., an MP3 player), a gaming console, a portable gaming device, and the like. It should be noted that although only one endpoint device 106 is illustrated in FIG. 1, the system 100 may include any number of user endpoint devices.

The search engine 114 is an application hosted, for example, on an application server 116 and configured to search the repository 102 upon a request from the endpoint device 106 (which may include search keywords). The search engine 114 ranks the results of such searches in accordance with the scores assigned by the score generator 104 before returning the results to the endpoint device 106.

Alternative configurations of the system 100 are possible. In one example, the score generator 104 is part of the search engine 114 rather than a separate component of the system 100.

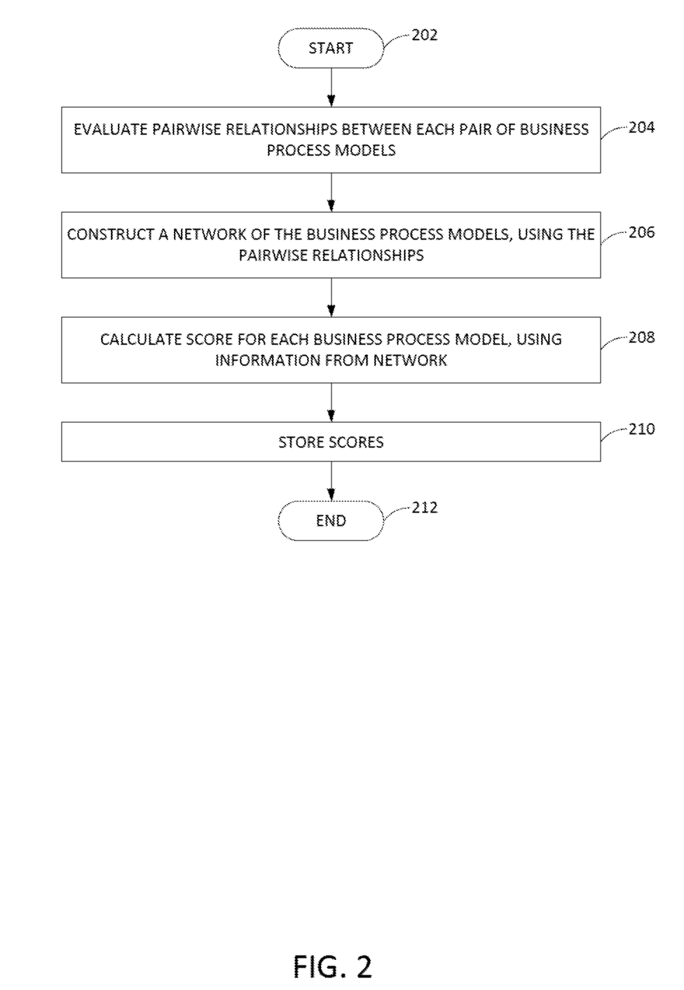

FIG. 2 is a flow diagram illustrating one example of a high level computer-implemented method 200 for determining the relevance of a business process model. The method 200 may be carried out, for example, by various components of the score generator 104 illustrated in FIG. 1 and described in detail above.

The method 200 begins in step 202. In step 204, the pairwise relationships between each pair of business process models in the repository are evaluated. In one example, the pairwise relationship is a temporal relationship and/or a substantive relationship. A temporal pairwise relationship relates to the time order between two business process models (e.g., which business process model was created or uploaded into the repository 102 first). A substantive pairwise relationship relates to overlapping content shared by two business process models (e.g., a percentage of shared content or specific sections of content that are shared). In one example, each business process model is reformatted into a standard form (e.g., Business Process Modeling Notation format) prior to evaluation to facilitate comparison.

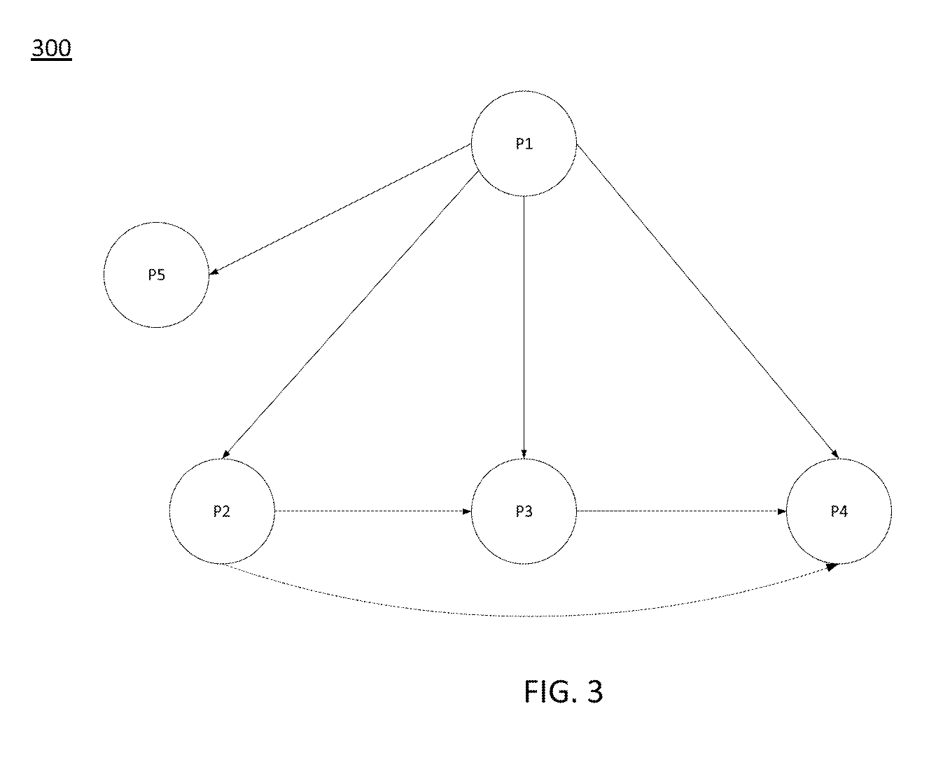

In step 206, the pairwise relationships are used to construct a network of the business process models. FIG. 3, for example, illustrates an example network 300 of business process models. As illustrated, the network comprises a plurality of nodes (P1-P5), where each node represents one of the business process models. In addition, the network includes a plurality of edges connecting the nodes. An edge between two nodes indicates that there is a substantive relationship (e.g., an overlap in content, through an inheritance relationship) between the business process models represented by the nodes. In addition, each edge may include an arrowhead that indicates the temporal relationship between the business process models (e.g., where the arrowhead points to the business process model that was created or uploaded later in time). Thus, the network encodes or models the pairwise relationships among the business process models in a hierarchical manner. Once example of a computer-implemented method for building a network of business process models is discussed in greater detail in connection with FIG. 4.

In step 208, a score is calculated for each business process model. The score is an indication of the business process model's relevance, and the score takes into account certain data obtained from the network constructed in step 206. For instance, the score for a business process model may be calculated at least in part by traversing the network for the business process model's pairwise relationships. Thus, the relevance of a given business process model is based largely on the business process model's relationships to other business process models in the repository. One example of a computer-implemented method for calculating a score for a business process model is discussed in greater detail in connection with FIG. 5.

In step 210, the scores for the business process models are stored. In one example, the scores are stored in the repository (e.g., with the associated business process models).

The method 200 ends in step 212.

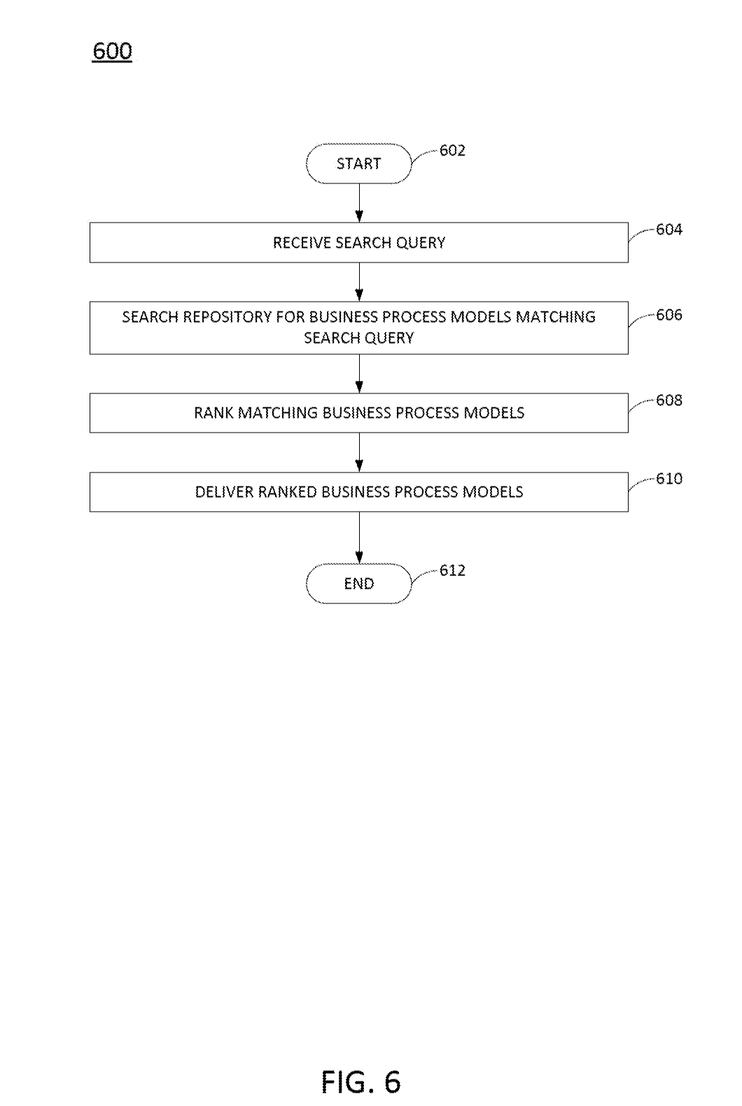

Once the network and the relevance of each business process model in the repository is established, this data may be used to improve the results of searches performed in the repository. In one example, the scores are used to rank results obtained through a keyword search, so that the results are sorted according to relevance. One example of a computer-implemented method for searching a repository of business process models is discussed in greater detail in connection with FIG. 6.

FIG. 4 is a flow diagram illustrating one example of a computer-implemented method 400 for constructing a network of business process models. The method 400 may be carried out, for example, by the network builder 110 illustrated in FIG. 1 and described in detail above to build a network similar to that illustrated in FIG. 3.

The method 400 begins in step 402. In step 404, a set of business process models is obtained (e.g., from a repository). Each of the business process models will be represented in the network by a node. Thus, the terms “business process model” and “node” are used interchangeably in the context FIG. 4.

In step 406, the business process model that was created or uploaded earliest in time is identified as the “starting node.” For instance, in FIG. 3, this business process model is identified by the node P1.

In step 408, an edge is inserted between the starting node and any other nodes that share at least a threshold amount of content with the starting node (hereinafter referred to as “child nodes”). For example, an edge may be created between the starting node and any other nodes that share at least x percent of their content with the starting node. For instance, in FIG. 3, edges are present between the starting node P1 and P1's child nodes P2, P3, P4, and P5. One edge is created for each of the child nodes, so that any number of edges may be created in step 408. In addition, an arrowhead is added to the edge that points to the child node to indicate that the corresponding business process model was created or uploaded later in time (i.e., more recently). In a further example, an edge is automatically created between each pair of child nodes, but some of these edges may be removed or updated later, as discussed below. In FIG. 3, potential edges between some pairs of child nodes are illustrated by dashed lines.

In step 410, the pairwise relationships for each pair of child nodes in the set are updated. As discussed above, this may involve updating or even removing edges that were automatically created in step 408. In one example, updating these pairwise relationships involves removing the edge between the any two child nodes for which at least a threshold amount of their shared content originated from the starting node. This threshold amount can be less than one hundred percent of the shared content. Furthermore, content shared by at least two nodes can be assumed to have originated with the node that was created or uploaded earlier in time. For example, referring again to FIG. 3, if all of the content shared by child nodes P2 and P3 is the same as the content shared by the starting node P1 and child node P2, then it can be assumed that some of the starting node P1's contents are inherited by both child nodes P2 and P3 (e.g., rather that the content being inherited by child node P3 from child node P2). In this case, the edge that was automatically inserted between child nodes P2 and P3 can be removed. However, in a further example, if at least a threshold amount of the content shared by two nodes did not originate from a common parent node, then the edge between the two nodes cannot be removed.

In a further example, if two child nodes share content that does not originate from the starting node, then the percentage of content shared by the two child nodes and not originating with the starting node is calculated. If the percentage does not meet or exceed the threshold amount of content, then the edge between the two child nodes is removed. For example, referring again to FIG. 3, if the content shared by child nodes P2 and P4 is different from the content shared by staring node P1 and child node P4, then it can be assumed that some of child node P4's contents are inherited from child node P2. In this case, the percentage of content shared by child nodes P2 and P4 is recalculated, this time excluding from the calculation content that is common to starting node P1 and child nodes P2 and P4. If the recalculated percentage still meets or exceeds the threshold, then the edge that was automatically inserted between child nodes P2 and P4 stays; if the recalculated percentage no longer meets or exceeds the threshold, then the edge that was automatically inserted between child nodes P2 and P4 is removed.

In step 412, each of the child nodes in the set is examined for the existence of any additional parent nodes (i.e., any parent nodes that are not the starting node). The additional parent nodes for a child node will include any other nodes that both: (1) shared content with the child node; and (2) were created or uploaded prior in time to the child node. Any nodes meeting these two criteria are identified as additional parent nodes, and edges are inserted between the child nodes and the additional parent nodes.

In step 414, if any of the additional parent nodes are parent to more than one of the child nodes, then the pairwise relationships for each pair of child nodes belonging to the additional parent node are updated. In one example, updating these pairwise relationships involves performing operations similar to those discussed in connection with step 410. In a further example, updating the pairwise relationships in step 414 further includes inserting an edge between an additional parent node and any unconnected child nodes of the additional parent node (i.e., child nodes of the additional parent node that are not yet connected to any other nodes). In this case, the pairwise relationships between the newly-connected child nodes and other child nodes are also updated using operations similar to those discussed in connection with step 410.

In step 416, it is determined whether any unconnected nodes remain in the set of business process models obtained in step 404. That is, it is determined whether there are any nodes whose connections to other nodes have not yet been examined. If it is determined in step 416 that no unconnected nodes remain, then the method 400 ends in step 420.

Alternatively, if it is determined in step 416 that there are remaining unconnected nodes, then the method proceeds to step 418. In step 418, any child nodes for the existing child nodes in the set are identified. An edge is inserted between each existing child node and each of its respective child nodes.

The method 400 then returns to step 410 and proceeds as described above to evaluate and update the relationships of the newly connected nodes. Thus, steps 410-416 essentially iterate until all nodes in the set of business process models have been evaluated.

FIG. 5 is a flow diagram illustrating one example of a computer-implemented method 500 for assigning a score to a business process model. The method 500 may be carried out, for example, by the relevance calculation processor 112 illustrated in FIG. 1 and described in detail above.

The method 500 begins in step 502. In step 504, a network of business process models is obtained. The network may be constructed in the manner described above with reference to FIG. 4.

In step 506, an initial score of 1/N is assigned to every node in the network, where N is the number of nodes in the network. It is noted that the number of nodes in the network is not necessarily the same as the number of business process models stored in the repository, since the repository may store more than one network.

In step 508, the node whose score is to be calculated is selected.

In step 510, the selected node's score is calculated. In one example, the score for a given node n is calculated as:

f(ancestor(n), child(n), edge parameters) (EQN. 1)

where the function f can be defined according to the search purpose. As an example, a node can be considered to be “relevant” when a threshold amount of its content is reused by other nodes. In this case, the function f can be defined as a function that increases monotonically in relation to the number of child nodes associated with the node being evaluated and in relation to the amount of content shared by the node being evaluated and its child nodes. As another example, a node can be considered to be “relevant” when it contains a threshold amount of unique content. In this case, the function f can be defined as the difference between the content unique to the node being evaluated and the content shared by the node being evaluated and all of its ancestor nodes.

EQN. 1 can be evaluated in a number of ways, including via elementary update or matrix operation. In one example, the score of each node is updated iteratively until convergence. In one particular example, the score can be calculated by rewriting EQN. 1 as:

f₁(ancestor(n), edge parameters)+f₂(child(n), edge parameters) (EQN. 2)

where the function f₁ tends to “consume” or detract from a node's score (because any shared content is more likely to originate with the ancestor) and the function f₂ tends to “provide” or add to a node's score (because any shared content is more likely to originate with the node being evaluated).

The method 500 ends in step 512. The score for the node may be stored in the repository or elsewhere (e.g., in other local or remote storage).

FIG. 6 is a flow diagram illustrating a high level computer-implemented method 600 for searching a repository of business process models. The method 600 may be carried out, for example, by a search engine such as the search engine 114 illustrated in FIG. 1 and described in detail above.

The method 600 begins in step 602. In step 604, a search query is received. In one example, the search query comprises a string of one or more keywords. The search query may be received from an endpoint device operated by a user.

In step 606, the repository is searched for business process models that match the search query. For example, business process models having content and/or metadata that matches one or more of the keywords specified in the search query may be identified.

In step 608, the matching business process models are ranked according to their scores. In one example, the scores are assigned in the manner discussed above in connection with the previous Figure. In one example, the matching business process models are ranked from highest score to lowest score, although in other examples they may be ranked differently (e.g., lowest score to highest score). In another example, additional criteria may be used to further refine the rankings, such as the ages of the business process models, the frequencies with which the business process models are accessed, scores associated with authors of the business process models, or other criteria. These additional criteria may be user-specified.

In step 610, the ranked search results are delivered to the user. For example, the ranked search results may be delivered to an endpoint device operated by the user.

The method 600 ends in step 612.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Examples of the present disclosure may be a system, a computer-implemented method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

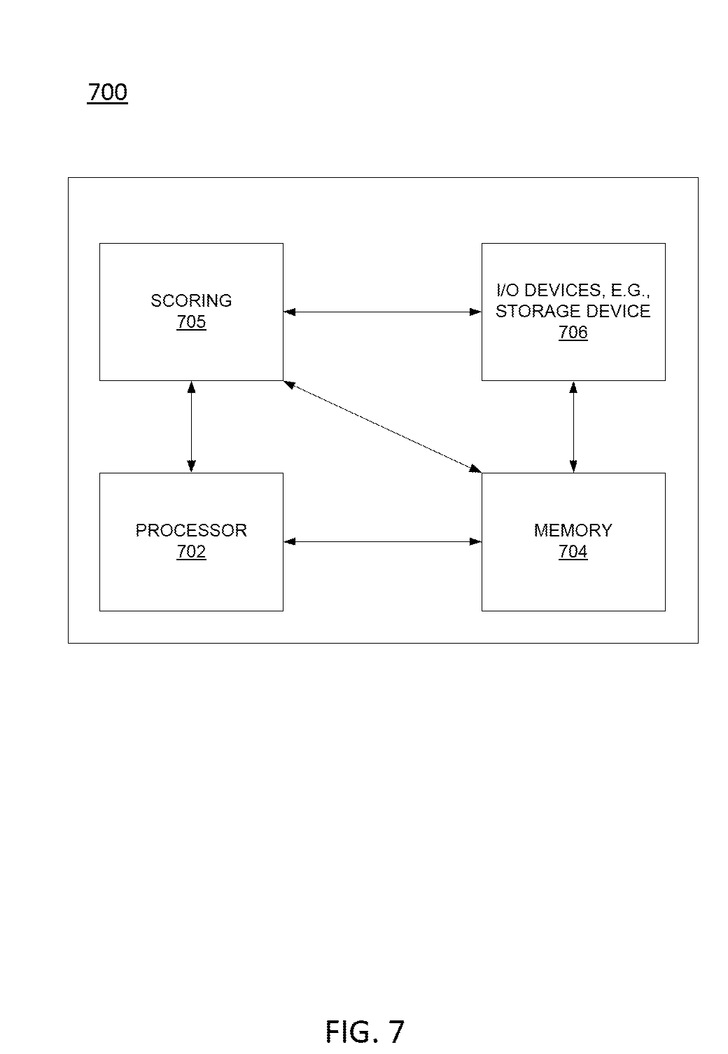

FIG. 7, for example, depicts a high-level block diagram of a computer 700 that can be transformed into a machine capable of performing the functions described herein. The computer 700 may comprise, for example, part of the score generator 104 or the application server 116 discussed above in connection with FIG. 1. Notably, no computer or machine currently exists that performs the functions as described herein. As a result, the examples of the present disclosure improve the operation and functioning of the general-purpose computer to score entries in a repository of business process models to facilitate searching, as disclosed herein.

As depicted in FIG. 7, the computer or system 700 comprises a hardware processor element 702 (e.g., a central processing unit (CPU), a microprocessor, or a multi-core processor), a memory 704, e.g., random access memory (RAM) and/or read only memory (ROM), a module 705 for scoring entries in a repository of business process models to facilitate searching, and various input/output devices 706 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed manner for a particular illustrative example, i.e., the steps of the above method(s) or the entire method(s) are implemented across multiple general-purpose computers, then the general-purpose computer of this figure is intended to represent each of those multiple general-purpose computers.

It should be noted that the present disclosure can be implemented in software and/or in a combination of software and hardware, e.g., using application specific integrated circuits (ASIC), a general purpose computer or any other hardware equivalents, e.g., computer readable instructions pertaining to the respective systems and/or methods discussed above can be used to configure a hardware processor to perform the steps functions and/or operations of the above disclosed systems and methods. In one embodiment, instructions and data for the present module or process 705 for scoring entries in a repository of business process models to facilitate searching (e.g., a software program comprising computer-executable instructions) can be loaded into memory 704 and executed by hardware processor element 702 to implement the steps, functions or operations as discussed above in connection with the exemplary system 100 and/or methods 200, 400, 500, and 600. The processor executing the computer readable or software instructions relating to the above described method(s) can be perceived as a programmed processor or a specialized processor. As such, the present module 705 for scoring entries in a repository of business process models to facilitate searching (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server. In addition, it should be noted that the hardware processor can be configured or programmed to cause other devices to perform one or more operations as discussed above. In other words, the hardware processor may serve the function of a central controller directing other devices to perform the one or more operations as discussed above.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer-implemented method, comprising:
evaluating pairwise relationships between pairs of business process models stored in a repository;
constructing a network that encodes the pairwise relationships; and
calculating a score for each of the plurality of business process models by traversing the network, wherein the score is a function of the pairwise relationships between an associated one of the plurality of business process models and others of the plurality of business process models.

2. The computer-implemented method of claim 1, wherein the pairwise relationships comprise temporal and substantive relationships.

3. The computer-implemented method of claim 2, wherein the network comprises:
a plurality of nodes, each of the plurality of nodes representing one of the plurality of business process models; and
a plurality of edges, each of the plurality of edges connecting two of the plurality of nodes, wherein the two of the plurality of nodes comprises two nodes whose corresponding business process models share an inheritance relationship with respect to at least a threshold amount of common content,
wherein each of the plurality of edges further includes an arrowhead indicating which of the two nodes was created more recently.

4. The computer-implemented method of claim 3, wherein the constructing comprises:
automatically inserting one of the plurality of edges between each pair of the plurality of nodes that share at least the threshold amount of common content; and
re-evaluating an inclusion of the one of the plurality of edges based on a source of the common content.

5. The computer-implemented method of claim 4, wherein the re-evaluating comprises:
removing the one of the plurality of edges when the source of the common content is a parent of the pair of the plurality of nodes.

6. The computer-implemented method of claim 4, wherein the re-evaluating comprises:
determining that the pair of the plurality of nodes share common content for which a source was not a common parent node; and
removing the one of the plurality of edges when an amount of the common content for which a source was not a common parent node fails to at least meet the threshold amount.

7. The computer-implemented method of claim 3, wherein the calculating comprises, for a given business process model of the plurality of business process models:
assigning an equal initial score to each of the plurality of business process models; and
computing the score as a function of: the initial score for each of the plurality of nodes representing an ancestor of the given business process model, the initial score for each of the plurality of nodes representing a child of the given business process model, and parameters of those of the plurality of edges that connect the node representing the given business process model to the nodes representing the ancestors and the children.

8. The computer-implemented method of claim 1, wherein the function is defined according to a purpose of a search of the repository.

9. The computer-implemented method of claim 8, wherein the purpose of the search is to find a business process model including at least a threshold amount of content that is reused by others of the plurality of business process models.

10. The computer-implemented method of claim 9, wherein the function increases monotonically in relation to a number of the others of the plurality of business process models and in relation to an amount of the content that is reused.

11. The computer-implemented method of claim 8, wherein the purpose of the search is to find a business process model including a threshold amount of content that is unique to the business process model.

12. The computer-implemented method of claim 11, wherein the function is defined as a difference between the content that is unique and content that the business process model shares with other business process models.

13.-18. (canceled)

19. A system, comprising:
a repository storing a plurality of business process models; and
an apparatus for scoring the plurality of business process models, the apparatus comprising:
a first processor for evaluating pairwise relationships between each pair of the plurality of business process models;
a network builder for constructing a network to encode the pairwise relationships; and
a second processor for calculating a score for at least one of the plurality of business process models, based on the pairwise relationships encoded in the network.

20. The system of claim 19, further comprising:
an apparatus hosting a search engine for searching the repository.
